(19) United States
(12) Patent Application Publication
(10) Pub. No.: US 2022/0343363 A1
(43) Pub. Date: Oct. 27, 2022

(54) CONNECTING OVER THE AIR RADIO TRANSMISSION CONTENT TO DIGITAL DEVICES

(71) Applicant: Sudhir DIDDEE, Redmond, WA (US)

(72) Inventor: Sudhir DIDDEE, Redmond, WA (US)

(21) Appl. No.: 17/765,687

(22) PCT Filed: Oct. 2, 2020
(86) PCT No.: PCT/US2020/054112

§ 371 Date: Mar. 31, 2022

Related U.S. Application Data
(60) Provisional application No. 62/909,580, filed on Oct. 2, 2019.

(51) Int. Cl. G06Q 30/02; H04H 60/31; H04H 60/90; G06N 20/00

(52) U.S. Cl. CPC G06Q 30/0252; G06Q 30/0242; H04H 60/31; H04H 60/90; G06N 20/00; H04H 2201/37

(57) ABSTRACT

Content synchronization with over-the-air radio transmissions captures user engagement and telemetry data. User engagement data creates a closed-loop feedback with over-the-air content and is tracked. User engagement and telemetry data feeds machine learning algorithms for radio station advertising effectiveness and programming refinement. User telemetry data identifies the listener radio receiving device. Machine learning applied to over-the-air advertising content categorizes ads for correlation with user behavior profile and ad effectiveness. Prediction models predict listener demographics and user engagement with advertising content in anonymous and registered mode. Over-the-air advertisements are synchronized with ad content provided to broadcast listeners on an electronic user device. Ad content may be listed, searched, and acted on by telephone, email, website click-through, including special ads and coupons targeted to users based on telemetry and user profile and behavior.

### CROSS REFERENCE TO RELATED APPLICATIONS

The present application claims the benefit of priority to U.S. Provisional Patent Application Ser. No. 62/909,580 entitled “CONNECTING OVER THE AIR RADIO TRANSMISSION CONTENT TO DIGITAL DEVICES”, filed on Oct. 2, 2019, the contents of which is incorporated by reference in its entirety.

### FIELD OF THE INVENTION

The present invention relates generally to over-the-air radio transmission of music, news, information, and advertisements. More particularly, the present invention relates to systems, methods and apparatus for synchronizing over-the-air radio transmission to digital content provided on digital devices and providing tracking of advertising effectiveness with reporting and dynamic adjustment for optimization of radio advertiser programming.

### BACKGROUND OF THE INVENTION

Music streaming, news and information streaming, and advertising through digital streaming applications are ubiquitous in the art. Music streaming through applications such as iTunes, Spotify, Pandora, and the like increasingly garner the attention of users of smartphones, tablets, and other handheld and desktop devices. While over-the-air radio broadcasting continues to be a player in the delivery of music, news, and information, digital streaming applications offer advantages to advertisers that are difficult to match with conventional over-the-air radio broadcast advertising.

The business model of many of the free streaming applications is to provide advertisements to users in exchange for free digital streaming content. As such, over-the-air radio broadcasting's free-to-all business model no longer holds the advantage that it once had in providing free music, news, and information content over the airways to anyone in its broadcast territory with a radio receiver. Over-the-air radio broadcasting also faces stiff competition for advertisers from a multitude of internet advertising options (Google, Facebook, Yelp, Zillow etc.). As a result, the market share of advertising revenue for the radio broadcast industry has declined precipitously in the last decade as digital content is increasingly provided over the internet.

Moreover, radio broadcasting is at a distinct disadvantage to digital streaming applications where the location of the listener on a smartphone, tablet, or other handheld device can be known from location data provided by the device itself. Radio broadcasting within a geographic area can be measured by reach and by awareness surveys, but to date, over-the-air radio broadcast has offered no way to determine, at the individual listener level, who is listening and from what location. In addition, listeners who may continue to receive radio broadcasting via a direct connection over the internet to the radio station streaming service do not currently provide opportunities for broadcast radio stations to earn advertising revenue from ads placed locally for listeners while traveling outside of their geographic area, for example, when stationed in foreign locations or when traveling for extended business or when traveling as a normal course of their occupation. In such cases, broadcast radio stations lose the benefit from local advertising by not taking advantage of and offering advertising targeted to the geographic area of listening while away from the home area.

In contrast, while streaming applications can use the location services of the digital device to target local advertising to local users, listeners do not enjoy the anonymity provided by listening to broadcast radio. Digital streaming services typically collect and aggregate massive personal data on the individual user which is then used for highly targeting advertising according to the listeners personal interests, past commercial transactions, social media profiles, financial profiles, and a host of other data. Coupled with precise location data, the advertisements can be tailored to the user and user location with increasingly sophisticated ad placement and dynamic pricing algorithms in ways that conventional radio broadcasts cannot.

Over-the-air radio broadcasting also suffers from its inability to provide measurable metrics to advertisers on radio advertisement effectiveness. In a typical streaming application, the user's interaction with the streaming application provides a direct measurement of whether the advertiser's product or service is of interest to the individual. The user's interaction and subsequent follow-through may be tracked by means such as providing ads with direct links to advertisers and product offerings from within the streaming application. Coded links provide advertisers with a measure of interaction from viewing, to clicking, to purchasing, as well as providing, typically, the user's contact information for follow-up digital interactions.

Despite their popularity, conventional online radio streaming applications, such as TuneIn, and Radio Player suffer from a number of drawbacks. Conventional online radio streaming application users cannot interact with the ads that are streamed to over-the air radio broadcasts. Online streaming radio applications allow a user to listen to advertising content, however, responding to an online radio ad content before the user has had a chance to save or recall the phone number or before the website mentioned in the ad has finished playing is challenging. Thus, online streaming and online radio streaming applications, like over-the-air radio broadcast, have remained largely an awareness engine for advertisers. Consequently, online streaming and online radio streaming application providers give advertisers very little metrics on measurable, tangible return on investment for radio advertising from radio stations, even when using other than over-the-air radio broadcast to reach listeners. Furthermore, online radio streaming users and over-the-air radio broadcast listeners, must call the radio station directly to participate in a sweepstakes, promotion or listener polls.

If over-the-air radio broadcasting is to survive the next decade, a new way of connecting radio content and advertising to radio listeners is needed. Radio stations need to provide specific metrics on advertising effectiveness to share with the advertisers. Radio stations needs to create new revenue streams and to introduce dynamic pricing for the advertising based on measurable and precise identification of listeners and listener follow-through. Radio stations need to engage listeners with advertisements which are highly relevant to the listeners interests and propensity to buy advertisers products and services based on user profile data and location.

### SUMMARY OF THE INVENTION

A system for connecting over-the-air radio transmission content to an electronic user device, in one aspect of the invention, having a radio station programming source for providing radio station programming content for radio broadcast transmission to one or more over-the-air radio broadcast listeners; one or more electronic user devices for receiving the radio broadcast transmission and presenting the radio station programming content to the one or more over-the-air radio broadcast listeners, a radio station synchronization server in communication with the radio station programming source and the one or more electronic user devices; wherein, the radio station synchronization server is configured to transmit programming content, including advertising content, via two-way communications with the one or more electronic user devices, and wherein, the programming content including advertising content is transmitted to the one or more electronic user devices for presentation to over-the-air radio broadcast listeners substantially synchronously with the radio station programming content received via the over-the-air radio station broadcast, and wherein, the radio station synchronization server is configured to receive from the one more electronic user devices, telemetry data including meta data on user behavior, motion, and engagement with the programming content including advertising content received via two-way communications with the radio station synchronization server.

In a second aspect, there is a method for connecting over-the-air radio transmission content to electronic user devices, the method including transmitting, by a radio station programming source, programming content via a radio broadcast transmitter to an over-the-air broadcast listener; transmitting, by a radio station synchronization server, programming content including advertising content via two-way communications to an electronic user device associated with the over-the-air broadcast listener; receiving, by the electronic user device of the over-the-air broadcast listener, the radio broadcast programming content and the radio station synchronization server programming content; presenting, to the over-the-air broadcast listener on the associated electronic user device, the radio station synchronization server programming content substantially synchronously with the radio station programming source content; capturing, at the electronic user device, meta data of listener engagement with the programming and advertising content; capturing, at the electronic user device, telemetry data; transmitting, to the radio station synchronization server via two-way communications, the meta data of listener engagement with the programming and advertising content and the telemetry data; and receiving, at the radio station synchronization server, the meta data and telemetry data for analysis and reporting.

In a first embodiment, the method as above may provide advertising content including advertiser contact information, including at least one of a telephone number, an email address, website address, or physical address, and a step of capturing meta data of user engagement with the advertising content includes connecting the user to the advertiser by a single-click interaction with the advertiser contact information.

In some embodiments, the method may include advertising content having special ad content, the special ad content including at least one of an offer, promotion, sweepstakes, or survey identified by a unique code, where the method further includes: transmitting the special ad content to the electronic user device; presenting the special ad content on a display of the electronic user device; and capturing meta data of user engagement with the special ad.

In further embodiments, the method may include performing machine learning/AI analytics to the telemetry data, wherein the telemetry data includes location, motion, and speed; identifying an over-the-air radio broadcast receiving device as a stationary radio, car radio, mobile radio, mobile phone used by a driver, bicyclist, pedestrian, or other mode of travel of the user based on at least the telemetry data; and selecting advertising content based on the identified receiving device for improving the relevance of advertising content transmitted to over-the-air radio broadcast listeners.

Further to this aspect, the method may include receiving telemetry data including accelerometer data on the speed of the electronic user device; determining whether the speed is greater than a threshold speed, within a range of speeds; or below than a threshold speed; comparing the determined speed with geographic data to predict the vehicle mode of the user of the electronic user device; and selecting advertising content correlated to the predicted vehicle mode of the user for improving the effectiveness of advertising content to over-the-air radio broadcast listeners.

In a further embodiment to the second aspect, the method may include performing machine learning/AI analytics to the radio station broadcast programming content for categorizing the advertising content; correlating the advertising content with the meta data of user engagement and user profile data; identifying the relevant text in the advertising content based on the meta data of user engagement and user profile data; and selecting advertising content correlated to the relevant text with high rates of user engagement for improving the relevance of advertising content to over-the-air radio broadcast listeners.

In some embodiments, the method advertising content may include audio content and identifying the relevant text further comprises a step of processing, by natural language processing, to extract key words and phrases for correlating with high rates of user engagement.

Further to the second aspect, the method may include performing machine learning/AI analytics on the meta data of user engagement with the programming and advertising content; correlating the meta data of user engagement with the programming and advertising content; selecting advertising content correlated to the meta data of user engagement for improving the relevance of advertising content to over-the-air radio broadcast listeners.

Further to the embodiments above, the method correlating the meta data of user engagement with the programming and advertising content may further include: performing machine learning/AI analytics on the captured telemetry data; correlating the captured telemetry data; and selecting advertising content correlated to the meta data of user engagement and to the telemetry data; wherein the telemetry data includes geolocation data of the electronic user device, and wherein the selecting of advertising content includes selecting advertising content correlated to the geolocation data for improving the local relevance of advertising content to over-the-air radio broadcast listeners.

Still further, the method may include performing machine learning/AI analytics on the meta data of user engagement with the programming and advertising content, where the performing further includes: capturing the meta data of user engagement and telemetry data in an anonymous mode; comparing the meta data of user engagement and telemetry data in an anonymous mode to registered listeners to predict the anonymous user preferences and demographics; predicting anonymous user engagement with advertising content based on the comparing of the meta data of user engagement in an anonymous mode to user engagement with advertising content and telemetry data of other listeners; and selecting advertising content correlated to the prediction of user engagement with advertising content for improving the relevance of advertising content to over-the-air radio broadcast listeners.

Still further to the above aspects, advertising content may include meta data associated with a demographic, age, income, lifestyle or location of listeners, the method further including: predicting anonymous listener demographic based on the meta data associated with the advertising content, and wherein selecting advertising content correlated to the prediction of user engagement further includes: selecting advertising content based on the predicted anonymous user demographics, age, gender, income, lifestyle or location.

In some embodiments, the method may include: associating an anonymous user with a registered user, the registered listener providing a known demographic; and comparing the received anonymous demographic to the known demographic of the registered listener; wherein the predicting anonymous user engagement with advertising content includes refining the prediction of the user engagement with advertising content based on actual user demographic and engagement with advertising content and telemetry data.

In a third aspect, there is an electronic user device in communication with a radio station programming content synchronization server, comprising: a user engagement module for capturing the user interactions via a user interface; a display module for displaying programming and ad content and other information on the electronic user device; a media player module for playing media content on the electronic user device; a configuration module for configuring the radio app to user preferences; an advertisement module for storing, retrieving, formatting, listing, and presenting advertisements displayed for user interaction; an authentication module for authenticating the user; a telemetry module for capturing user engagement data from interactions of the user with the radio station application; and a communications module for communicating programming and advertising content, telemetry data, and other data capture by the electronic user device. The electronic user device may include: a memory, a display, an input, a media player, and a processor and a memory with executable instructions stored thereon configured to: receive programming content transmitted via a radio broadcast transmitter to an over-the-air broadcast listener; receive, via two-way communications, programming content including advertising content transmitted from a radio station synchronization server, present, to the over-the-air broadcast listener on the electronic user device, the radio station synchronization server programming content substantially synchronously with the radio station programming source content; capture, at the electronic user device, meta data of user engagement with the programming and advertising content; capture, at the electronic user device, telemetry data; and transmit, to the radio station synchronization server via two-way communications, the meta data of user engagement with the programming and advertising content and the telemetry data for analysis and reporting.

In some embodiments of the third aspect, the electronic user device may display advertising content by the display module to include an ad banner, and wherein the ad banner includes a unique embedded telemetry beacon, and further comprise executable instructions configured to: present the ad banner on a display of the electronic user device; monitor the position of the embedded telemetry beacon on the display; capture meta data of user engagement with the ad banner; capture the position of the embedded telemetry beacon during user engagement with the ad banner; and based on the embedded telemetry beacon and user engagement meta data, identify the ad banner and ad banner views to obtain counts of viewing the ad banner by the user per unique advertisement.

Further to the third aspect, advertising content may include special ad content, wherein the special ad content includes a coupon or promotion identified by a unique code, and further comprising executable instructions configured to: present the special ad on a display of the electronic user device; capture meta data of user engagement with the special ad; and based on the telemetry data and the meta data of user engagement meta data, provide one or more of an offer, promotion, sweepstakes, survey to the user. The electronic user device may further comprise a vehicle mode determination module comprising executable instructions configured to receive telemetry data including accelerometer data on the speed of the electronic user device; determine whether the speed is greater than a threshold speed, within a range of speeds; or below than a threshold speed; compare the determined speed with geographic data to predict the vehicle mode of the user of the electronic user device.

In some embodiments, the electronic user device advertising content includes advertiser contact information including at least one of a telephone number, an email address, website address, or physical address, and wherein executable instructions stored thereon are further configured to: capture meta data of user engagement with the advertising content, and connect the listener via the electronic user device to the advertiser by a single-click interaction with the advertiser contact information.

In a further embodiment, the electronic user device advertising content includes special ad content, the special ad content including at least one of an offer, promotion, sweepstakes, or survey identified by a unique code, wherein executable instructions stored thereon are further configured to: receive the special ad content radio station programming content synchronization server; present the special ad content on a display of the electronic user device; capture meta data of user engagement with the special ad; and transmit, to the radio station synchronization server via two-way communications, the meta data of user engagement with the special ad content.

In a fourth aspect, there is a radio station programming content synchronization server, in communication with a radio station programming source and a radio station application executing on an electronic user device, comprising: a processor and memory having instructions stored thereon for execution by the processor configured to: receive, from a radio station content programming server, programming data on the radio station over-the-air broadcast transmission; receive, from an app configuration server, configuration and preferences data on radio broadcast listener and profile of the user/listener of the electronic user device; receive, from an ad feed server, advertising content selected based on the configuration, preferences, and profile of the user; and transmit the advertising content to the electronic user device for display substantially synchronously with the programming content received by the electronic user device via the over the air broadcast.

In some embodiments of the fourth aspect, the radio station programming content synchronization server may be in further in communication with: an app server for managing the features and preferences of the user of the radio station application; an Ad/AI processing server for performing analytics on programming content, telemetry data and meta data of user engagement with advertising content; a reporting server for reporting data regarding telemetry data, meta data on user engagement; and a campaign server for scheduling, selecting and setting advertising campaign parameters.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures.

FIG. 1 is a system view of a conventional over-the-air radio station programming broadcast transmission system;

FIG. 2 is a global system view of radio broadcast synchronization components, according to some aspects of the invention;

FIG. 3 depicts the components of an exemplary electronic user device;

FIG. 4 depicts a high-level flowchart of the operation of the system described herein for connecting over the air radio transmission content to digital devices system, according to one aspect of the invention;

FIG. 5 depicts a system component module view of a radio station software application the “radio app” according to some embodiments of the invention;

FIGS. 6A and 6B depict home screens of a radio app, according to one embodiment of the invention, showing user interface controls and user interface controls with displayed ad banner ad;

FIG. 7 depicts a user interface of radio app showing Playlist tab, according to one embodiment of the invention;

FIG. 8 depicts a user interface of radio app showing Ad Feed tab, according to one embodiment of the invention;

FIG. 9 depicts a user interface of radio app showing radio Ad Specials tab, according to one embodiment of the invention;

FIG. 10 depicts a user interface of radio app showing radio Settings tab, according to one embodiment of the invention;

FIG. 11 depicts an Ad/AI Processing server for ad data based on user activity and other data, according to one aspect of the invention;

FIGS. 12A and 12B depict the operations of an Ad/AI Processing server Prediction Module within the conventional over-the-air radio station programming broadcast transmission system;

FIG. 13 depicts a flowchart of the operation of the Prediction Module in the Ad/AI Processing server.

Reference is further made to the Appendices filed herewith for depictions of features and displays of the present invention, the appendices of which are incorporated by reference in their entirety.

### DETAILED DESCRIPTION

Generally, the systems, methods, and apparatus described herein provide for the connecting of over-the-air radio transmissions content to electronic user devices with the technical features, benefits and advantages below described for the various aspects and embodiments summarized above.

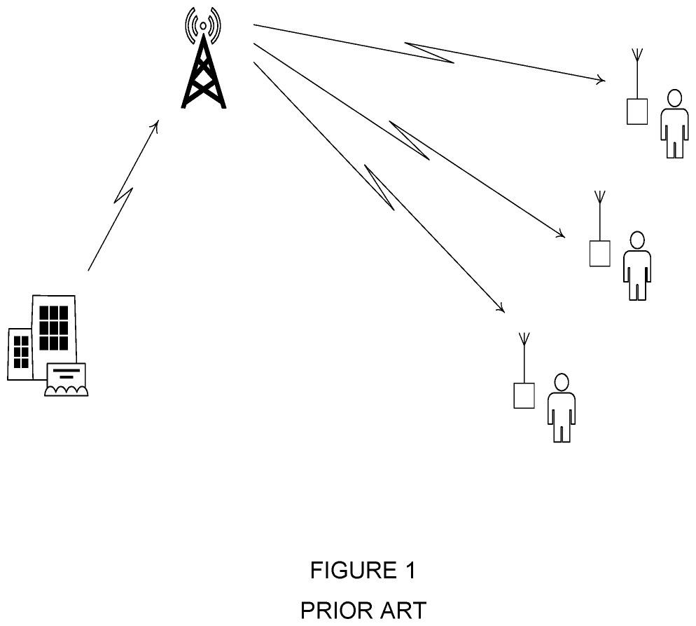

As shown in FIG. 1, there is a system for transmitting radio station programming from a radio station to over-the-air radio broadcast listeners. In one embodiment, radio station provides radio station programming from a radio station programming source to radio station transmitter. Radio station transmitter converts radio station programming to radio broadcast transmission to over-the-air radio broadcast listeners. Radio station listeners receive radio broadcast transmission via radio broadcast receivers. Radio broadcast receivers convert radio station broadcast transmission to radio station programming for presentation to over-the-air radio broadcast listeners.

Radio station may be a single radio station or multiple radio stations, affiliated or unaffiliated. Radio station may be manned or unmanned. Radio stations may be part of a media group, which may consist of one (1) to over a one thousand (1000) radio stations. Radio stations may be grouped by geographical areas, such as “Greater Los Angeles” or “New York Area”. Radio Stations may have different themes and audience for different genres, such as Pop Music, Country Music, Sports, News, Religious, etc. However, nothing in the above examples is necessarily limiting in the application of the present invention, as a Radio Station or Radio Station grouping may provide any of numerous formats and genres without departing from the invention described herein.

Radio Stations may provide radio station programming to radio station transmitters via a communications uplink. Radio station transmitters may transmit radio station broadcast to radio broadcast receivers by analog transmission frequency, e.g. FM or AM band analog transmission frequencies. Radio station transmitters may transmit in a band or bands of AM or FM, or radio stations may transmit in digital bands or high-definition (HD) digital bands. Radio station transmitters may be limited by radio signal propagation based on the power of the radio station transmitter, thereby defining a physical area within which a user may receive the broadcast radio station transmitter signal. Radio Station transmitter or transmitting technology may include satellite transmissions to satellite radio broadcast receivers. However, nothing in the above limits the application of the present invention to any particular form of radio station transmitter or transmitting technology, as a radio Station or radio station group may use any of and one or more of radio station transmitters or transmitting technology without departing from the invention as described herein.

Radio station programming may be provided for transmission by radio station transmitters by radio station using a radio programming source. Radio station programming may include, but is not limited to, programming content such as music, news, information, and advertisements. Radio programming source may include on-site generation of radio programming content or may retransmit radio station programming content via a communications downlink. Radio programming content source may include radio station-affiliated or third-party digital or analog media streaming providers or remote live broadcast programming content sources. A radio station or radio station grouping may generate content in the radio station studio and/or may receive content, such as songs or media content rights from the media content provider. Retransmissions of received programming content may be based on an affiliation with a network, wherein the local radio station may mix local advertising within and during timeslots made available for commercial breaks.

In some embodiments, over-the-air radio broadcast listeners may receive radio broadcast transmission via radio broadcast receivers. Radio broadcast receivers may be integral to electronic user devices including, but not limited to, handheld AM/FM or satellite radios. Analog radio devices are limited by the range and power of the radio signal. Radio broadcast receivers may be integral to a variety of electronic user devices integral to stationary devices including, but not limited to, stereo systems, TVs, receivers, speakers, in-wall radio devices, and radio devices streaming over-the-air broadcast radio signals through a personal computer, smart phone, and tablet computers. Radio broadcast receivers may be integral to non-stationary devices including, but not limited to, cars, trucks, bicycles, motorized and unmotorized personal transport vehicles.

In some embodiments, electronic user devices convert radio station broadcast transmission to radio station programming for presentation to over-the-air radio broadcast listeners. Presentation of radio station programming may include real-time or delayed-time playback of audible programming content including, but not limited, to music, news, information, and advertising containing music and/or news and information regarding products and services offered by radio station advertisers. The type and manner of presentation of radio station programming on electronic user devices may include, but is not limited to, Playlists, Ads, News, Weather and Traffic information in substantial synchronization with the over-the-air broadcast feed.

Presentation of radio station programming may include real-time or delayed-time playback of audible programming content including, but not limited, to music, news, information, and advertising containing music and/or news and information regarding products and services offered by radio station advertisers. In some embodiments, electronic user devices may convert radio station broadcast transmission to radio station programming for presentation of sound and images, in whole or in part, from video programming content to over-the-air radio broadcast listeners. Video programming content may include, but is not limited, to music video, news video, informational video, and advertising video containing music and/or news and information regarding products and services offered by radio station advertisers.

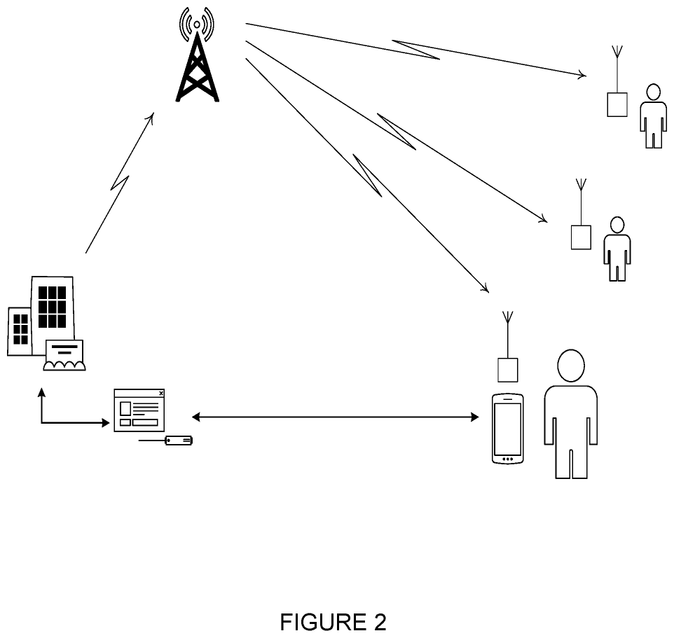

As shown in FIG. 2, there is a system for transmitting radio station programming from a radio station to over-the-air radio broadcast listeners. In one embodiment, radio station provides radio station programming from a radio station programming source to radio station transmitter. Radio station, radio station programming, radio station programming source, radio station transmitter, radio station broadcast receiver, and electronic user device are as described above, with all of the attended variations and configurations previously described.

Additionally, there is in FIG. 2 one or more electronic user devices and a two-way electronic communications path from the electronic device(s) to a radio station programming content synchronization server. Electronic user device(s) may include, but is not limited to, smartphones or tablet computer or in-car (or other transportation vehicle) navigation systems. The two-way electronic communications path may be, in some embodiments, a cellular network communications path, an internet communications path, WIFI, WLAN, or other TCP/IP communications means.

Radio station programming content synchronization server may reside at radio station, or may reside at a location other than radio station. Radio station programming content synchronization server as shown is in communication with radio station programming source. The operation, features, benefits and advantages of the radio station programming content synchronization server in communication with the one or more electronic user device(s) and the radio station programming source, as shown in FIG. 2 and various embodiments thereof, will be described in detail below.

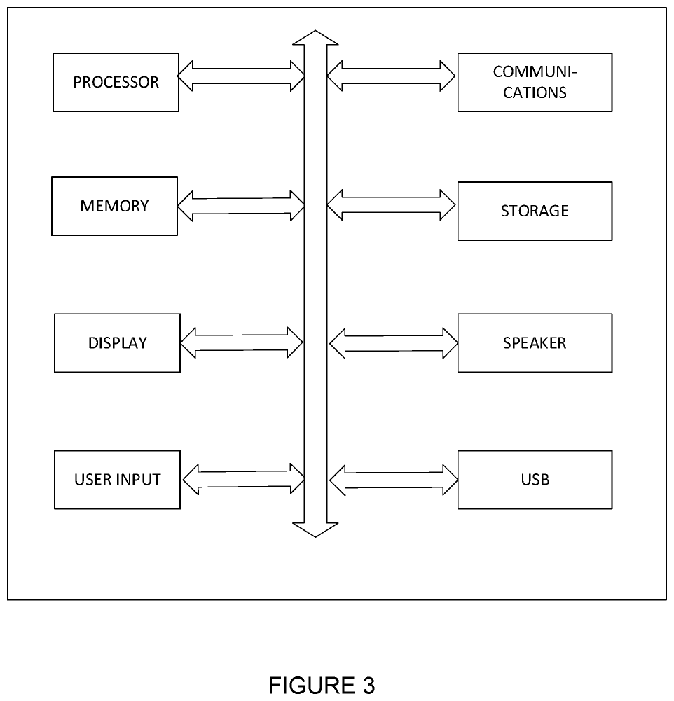

As shown in FIG. 3, there is an electronic user device capable of receiving and presenting radio programming content. Electronic user device includes a processor, a memory for storing programming content and instructions executable by the processor, a display, and a memory bus in communication processor, memory, and display for presenting programming content to the user of the electronic user device. Processor may include, but is not limited to, CPU, microcontroller, and application specific integrated chips (ASICs). Storage memory may include, but is not limited to, local RAM, SDRAM, and USB devices. Programming content may be stored in various forms, including but not limited to, files and data structures in the storage memory of the electronic user device. Instructions executable by the processor of the electronic user device may include, but are not limited to, operating system code, such as Android and iOS operating systems, application source code, assembly code, HTML code, Python code, or other high-level programming language code known to one skilled in the art. Display may include, but is not limited to an LCD display, an OLED display, or other display technology known to one skilled in the art as may be conventional provided by an electronic user device. User input for receiving instructions from the user may include, but is not limited to, touch screen, buttons, keys, voice command input. In a preferred embodiment, electronic user device includes location-detection. Location detection may include, but is not limited to, GPS, cellular tower triangulation, Wi Fi router location, and fixed locations such as zip code, building, structure or street address.

Electronic user device also includes, as shown in FIG. 3, a data communications device in communications with the radio station programming content synchronization server and a media playback device. Electronic user device may receive and transmit two-way communications by cellular communications, analog or digital communications, satellite communications, fixed line and wireless communications. Instructions executable by the processor of the electronic user device may include operating system instructions, display instructions, user input instructions, storage memory instructions, and media playback instructions. Media playback instructions may include instructions to play music content, video content, voice content. Media playback instructions may include presentation of music, video and voice content in real-time, “live” streaming, from stored content, or delayed content and storage. Instructions may be configured as system or application (“app”) programming files for performing any or all of the functions described herein for the connecting of over-the-air radio transmissions content to electronic user devices.

Provided in the connecting over the air radio transmission content to digital devices system, there is a synchronization server device capable of performing the operations of a radio station programming content synchronization application to be more fully described below. Synchronization server device includes a processor, a memory for storing programming content and instructions executable by the processor, and a memory bus in communication processor, memory. Processor may include, but is not limited to, CPU, microcontroller, and ASIC. Storage memory may include, but is not limited to, RAM, SDRAM, USB memory stick. Programming content may be stored in various forms, including but not limited to, files, data structures, network storage. Instructions executable by the processor may include, but are not limited to, operating system code, such as the Windows 10™, Linux OS operating systems, application source code, assembly code, HTML code, Python code. Synchronization server may include a display such as an LCD display, OLED display, CRT display or other conventional display technology. User input for receiving instructions from the user may include, but is not limited to, touch screen, buttons, keyboard, voice command input.

Synchronization server may also include a data communications device in communications with the radio station programming source. Server device may receive and transmit two-way communications by cellular communications, analog or digital communications, satellite communications, fixed line and wireless communications. Instructions executable by the processor of the server device may include operating system instructions, display instructions, user input instructions, storage memory instructions, and media playback instructions. Media playback instructions may include instructions to play music content, video content, and voice content. Media playback instructions may include presentation of music, video and voice content in real-time, “live” streaming, from stored content, or delayed content and storage. Instructions may be configured as system or application (“app”) programming files for performing any or all of the functions described herein for the connecting of over-the-air radio transmissions content to electronic user devices.

The operation of the system as shown and previously described for FIGS. 2 and 3 according to some aspects of the connecting over-the-air radio transmission content to digital devices system will now be illustrated.

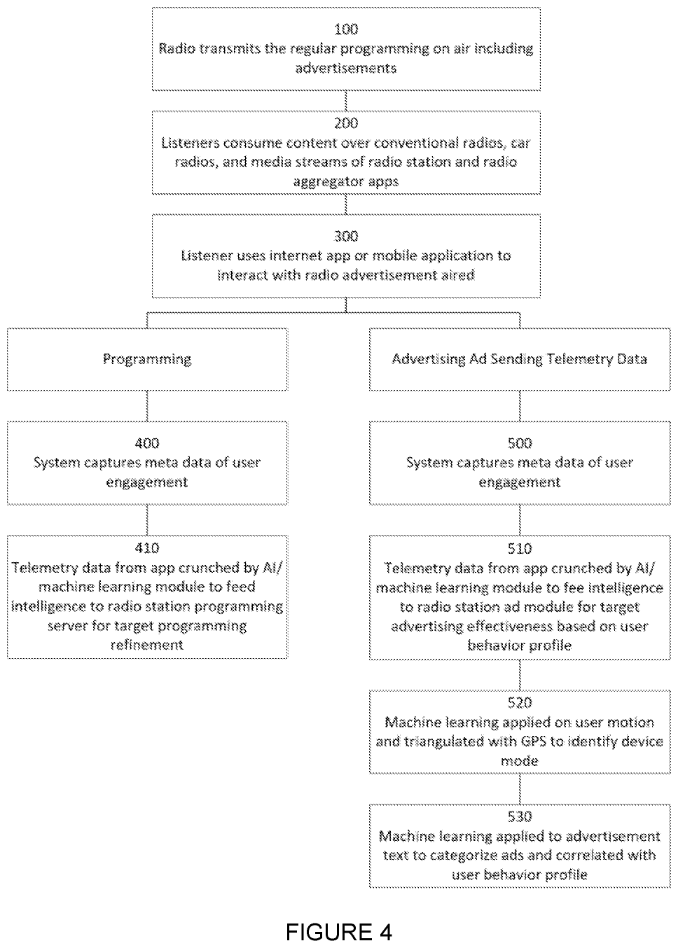

As shown in FIG. 4, there is a flow chart of the operation of the connecting over-the-air radio transmission content to digital devices system according to one aspect of the invention. At step 100, the radio station programming source transmits programming content, which may include audible programming content including an advertisement, via radio broadcast transmitter to an over-the-air broadcast user. Substantially simultaneously to the transmission of the radio broadcast programming content, radio station programming content synchronization server sends, via two-way communications, programming content including an advertisement to the electronic user device associated with the over-the-air broadcast user.

At step 200, the radio broadcast transmission is received by the radio broadcast receiver associated with an over-the-air broadcast user and the radio station programming content is presented to the over-the-air broadcast listener on the electronic user device.

At step 300, the over-the-air broadcast user receives the synchronized programming content including advertising content on the electronic user device associated with the user and engages with an input of the electronic user device. Integration with industry standard media player application to stream the media over the internet via a connected data service may be consumed in the electronic user device, on a specialized app, or may alternatively be streamed to a standard user industry browser.

At step 400, the electronic user device radio captures meta data of user engagement with the advertising content provided by the synchronization server. Synchronized the over-the-air content programming content including advertisement content on electronic user device allows the user to interact with the advertisement content or the programming content (e.g. songs, talk shows, sports programming, and the like). Meta data of user engagement with may include, but is not limited to, the album, song or talk show content, radio host or DJ, time of day, type of over-the-air radio receiver device, type of electronic user device, mode of listening and medium of reception, mode of reception radio or streaming by fixed or wireless, type of interaction by the user with the programming content, and the manner and frequency or counts that a user interacts with a particular ad. Visual clues and interactivity provided to the user on the electronic user device allows the user to make phone calls, email the advertiser, find driving directions to the physical location of the business, and to save the advertisement for follow up later and share it on their social network. Interactivity with the programming content may include a one-click connection to an advertiser by the user clicking on a displayed advertiser link, including an advertiser telephone number, website, email address, or physical address.

Advertising content may be tailored by the advertiser based on user demographics, for example, an advertiser may target different products for male and female audiences or age-based targeting as knee replacement surgery may only be targeted to users over a certain age, or to users in a specific age range. For example, an ad shown on the electronic user device may show a different ad for the advertiser based known or predicted user preferences, which may include an advertisement having different content or subcontent, such as graphics, depending on the users known or predicted gender or age.

Advertising content may be restricted to advertising age-appropriate or legally appropriate advertising content for gambling, alcohol or tobacco for users under the appropriate or legal age of purchase or consumption. Advertising content may be for special ads and coupons may be based on user demographics and prior user interactions with programming content including past advertising content. In some embodiments, an integrated survey module allows radio stations to administer surveys on behalf of the advertisers, and users may participate in contests and sweepstakes with a single click without the need to fill out forms.

As further described herein, users may or may not be identified to the system by personally identifiable information (PII). Interactivity and participation may nonetheless proceed without compromising users' privacy. In such embodiments, user interactivity and participation may be tracked and stored by an electronic device identification number, such as a device ID, MAC, or other identifier, while the anonymity of the user is maintained. User interactivity and participation data can be stored and later accessed for predictive analysis of unknown users. Unknown users that later agree to be identified can register on the radio app and such users' interactivity and participation data can then be united with the stored interactivity and participation data for verification of predictive models and for immediate access to past activity, thereby instantly providing a rich history of interactivity for better advertisement targeting. As will be described more fully below, the uniting of previously anonymous users' past activity data may be used to compare to the performance of a prediction algorithm for more precise targeting of ads to both known and unknown radio app users.

In one embodiment, at step 410, the system captures telemetry data from the electronic user device including location, speed of motion. Types of telemetry data captured by the system may include, but is not limited to, device identification, device location as latitude and longitude, in some embodiments, to within several hundred feet of the user location, ad clicks, banner clicks, clicks to the phone, mail, social medial, favorites, songs liked, songs disliked, coupons clicked and the direction buttons employed by the user to navigate menus of the apps running on the electronic user device. Telemetry data and user engagement meta data is transmitted to the radio station synchronization server for analysis and reporting.

In another embodiment, at step 500, the system captures telemetry data from the electronic user device including location, speed of motion. Types of telemetry data captured by the system include, but is not limited to, device ID, device location as latitude and longitude to approximately several hundred feet, preferably within 300 feet, of the user location, ad clicks, banner clicks, clicks to phone, mail, social media, favorites and directional buttons employed by the user.

Analysis and reporting of the meta data may include, at step 510, applying artificial intelligence and/or machine learning on the telemetry data. Telemetry data may be analyzed by artificial intelligence and machine learning to feed analysis to a radio station programming system to target programming refinements for increased user engagement and time the user spends listening to the radio station. In one aspect of the invention, telemetry and user behavior analytics may provide analytics to the station on the host and time of day for optimizing programming content for more effective user engagement. The radio station may dynamically change the programming content based on telemetry and listener engagement data based on recommendations by the artificial intelligence and machine learning recommendation engine to increase listener loyalty to the radio station programming content.

At step 520, machine learning applied to the telemetry data may include analysis of telemetry data on location, motion, and speed to identify the over-the-air radio broadcast receiving device at a stationary radio, car radio, mobile radio, mobile phone used by a driver, bicyclist, pedestrian, or other mode of travel of the user.

At step 530, machine learning may be applied to the programming content include advertising text to categorize the advertising content and to correlate the advertising content with the user engagement and behavior profile.

In some embodiments, machine learning may be applied on the advertisement text to categorize the ads and correlate it with user behavior profile may determine the most relevant ad for the user based on user demographics. In one embodiment, over-the-air radio broadcasts are stored to audio files which are converted by natural language processing to text for identifying the relevant text in the ad that drives the highest click through for various types for user responses when interacting with the ad on their mobile or internet devices. Based on the user engagement and click through data analysis, recommended ads having text with higher response rates may be displayed to the user to increased engagement and improve the relevance of advertising content to over-the-air radio broadcast listeners.

The operation of the components of the system as shown and previously described for FIGS. 1-4 according to some aspects of the connecting over-the-air radio transmission content to digital devices system will now be described.

In a further aspect of the connecting over-the-air radio transmission content to digital devices system, there is installed on the electronic user device a radio application (the “radio app”).

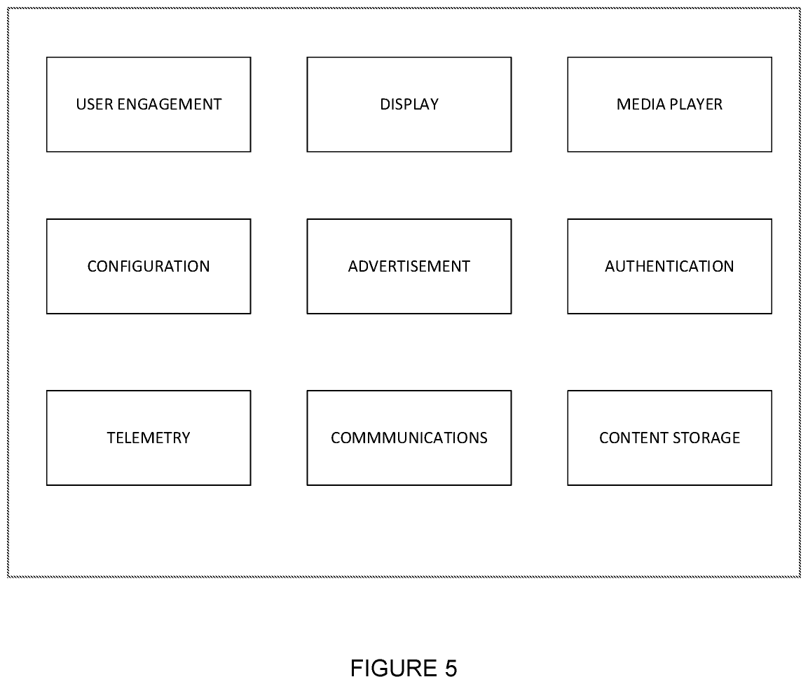

The radio app will be further described in view of FIG. 5 and further in view of various embodiments, including modules and user interfaces of the radio app and the operation thereof. As shown in FIG. 5, radio app includes modules:

a user engagement module for capturing the user interactions via a user interface;

a display module for displaying programming and ad content and other information on the electronic user device;

a media player module for playing media content on the electronic user device;

a configuration module for allowing the user to configure the radio app to his or her preferences;

an advertisement module for storing, retrieving, formatting, listing, and presenting advertisements which may be aired on the radio and displayed for user interaction;

an authentication module for authenticating the user to allow viewing of ad content to save the ad and to participate in contests conducted by the radio station;

a telemetry module for capturing all the data from the interactions that the user has with the application, for example, clicking on the song, liking the songs, clicking on weather, traffic, ad banner, ad phone numbers, and ad business addresses; and

a communications module for communicating programming and ad content, telemetry data, and other data of the user between external servers and database and the electronic user device.

Configuration module provides for customization of the radio app. Customizations of the radio app may be based on a default configuration which may be updated periodically. Configuration module may include customizations of predefined user interface and display themes, e.g. Light, Dark, Magenta, etc. Configuration module may include customizations based on a theme associated with one or more over-the-air radio stations. Themes may be packaged with the radio app so that users may easily switch themes or select custom themes which may be downloaded and applied from an external application server. Configuration module may further provide customization of tabs and modules with predefined module parameters which may be customized based on the module parameters for a specific over-the-air radio station, including the radio station call letters and other branding identifiers including, but not limited to slogans, internet address(es), and personal or program identifiers. Configuration module may also provide for the enabling or disabling of features and modules, and the customization of settings and modules by the user or by an external application server. Configuration module may also provide for setting locale parameters, e.g. country, region, language, keyboard, etc., for customizing the radio app to the locale. In some embodiments, configuration module may use telemetry data for customization of the locale parameters of the radio app.

In other embodiments, the radio app may analyze user behavior for configuration and customization of the radio app configuration parameters. In general, configuration parameters include any and all settings of any and all modules and capabilities of the radio app, which parameters are not limited by the enumerated examples above.

Authentication module may include sign-in functionality using Google, Facebook, or any industry-standard authentication service permitting user access to the radio app based on user information at the respective authentication service provider.

Display module may include visual and audible presentation capability for displaying programming content including media streaming content and advertising content. Display module capability is further described below in reference to the radio app user interface displays.

Media player module may include radio station programming content streaming capability, such as the playback, in real-time or delayed, of programs and songs.

User Engagement module may include user engagement capture capability. User Engagement module capability is further described below in reference to the radio app user interface displays.

Ad Banner module may include ad banner selection and display capability. Ad Banner module display capability is further described below in reference to the Home, Ad Feed and Ad Specials display screens.

In one aspect of the invention, Ad Banner module may provide for presenting and tracking banner ads configured with an embedded telemetry beacon. An embedded telemetry beacon, according to this aspect, may provide for a code or codes to be included in an ad banner graphic as a numerical code, or a pixel code, or as one or more numerical or pixels codes or combination thereof.

In some embodiments, an embedded telemetry beacon may be embedded in an ad banner or ad information graphic at a particular pixel location identified by one or more row(s) and column(s) of the graphic image. The embedded telemetry beacon may comprise a single pixel or multiple pixels at known pixel locations, each embedded telemetry beacon pixel represented by a number range, for example, a range from 1 to 255 (a black and white pixel), or preferably a range of 1 to 16,777,215 of a full-color (24-bit) pixel code.

Operation of the embedded telemetry beacon is as follows: an ad banner containing an embedded telemetry beacon is displayed; the display of the ad banner identified by the numerical or pixel code at the expected row and column of the ad banner for a minimum duration on the display of the electronic user device is registered by the display module; the display module records and stores data based on a particular ad banner being displayed to the user, at a particular location on a particular user interface and layout for a measured time; and the recorded and stored data is included in user engagement data to be later analyzed.

Operation of the embedded telemetry beacon includes a beacon embedded on an ad banner for sending metric data to a reporting server whenever a banner is scrolled and the banner appears in focus of the users viewing screen on the electronic user device. In some embodiments, when the full banner is shown from a top beacon to a bottom beacon, the analysis may count the ad banner as having been presented to the user as a single view of the banner. In other embodiments, the total banner views per advertisement and subsequently per advertiser may be analyzed as one advertiser, which may have multiple banners which are aggregated and reported.

Telemetry module may include capturing and sending to an external ad server meta data and user engagement with programming content including ad content. Telemetry data may include, but is not limited to, ad impressions (advertisement views by the user), ad clicks, and ad identifiers, including ad size, ad type, ad banner, and advertiser name and information. Ad Type may include the ad feed or special ad or promotion to be further described below. Telemetry data on user engagement may include time of day, ad spot length, location, user profile and radio app usage data, as well as radio app and module versions or experimental radio app or module identifiers. Telemetry module may provide data sent at upon a radio app session start, including all details and subsequent additional data with a session id.

Communications module may include communications programming instructions and configuration settings for two-way communications with authentication servers, synchronization servers, ad servers, reporting servers, and other servers and services. One skilled in the art would understand that any of known configurations and protocols for data communications between applications and application servers and services may be employed without loss of generality as to the features and benefits of the radio app described herein.

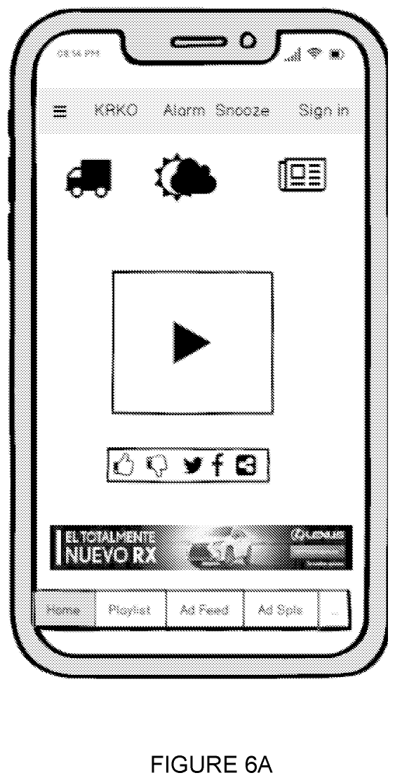

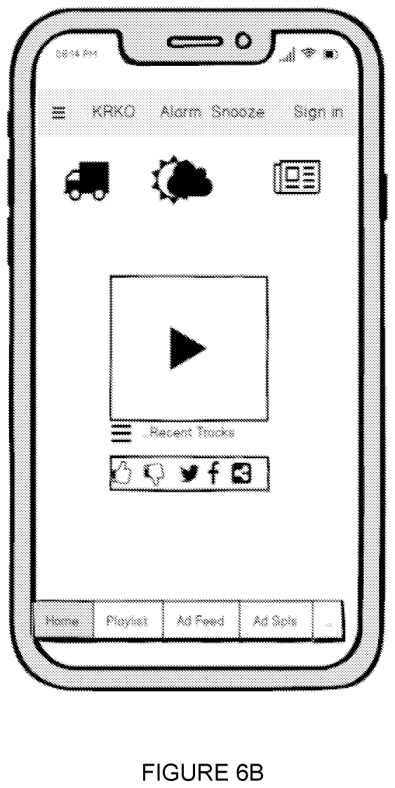

Operation of the various modules of the radio app will now be described with reference to FIGS. 6-10 depicting user interfaces provided to the over-the-air radio listener associated with the electronic user device as above described.

As shown in FIG. 6A, there is a home screen displayed on the electronic user device, according to one embodiment. As conventionally provided, such as on a smartphone display screen, a current time, cellular connectivity status, wireless connectivity status, and battery power status indicators may be displayed at a top portion of the screen. Within the radio app portion of the smartphone display screen, there is a menu bar showing a selected over-the-air radio station, by name (e.g. KRKO or KXA) or alternatively by logo, an Alarm control, a Snooze control, and a Sign-in control. Alarm control may provide users with an indication of a radio station programming content schedule. Sign-in control may use a local radio app sign in function or may use a social media account authentication service such as Facebook, Google, or a Microsoft authentication service.

In some embodiments, sign-in control by a social media authentication service may additionally provide user profile information for use by the radio app, such as gender, age, address, or other user profile information or identifier. Sign-in by social media may further grant the radio app permission for read-only access to calendar events and event information, including contacts and contact information. Social media sign-in may provide additional information related to user interests in shopping or fashion, a user's hometown, personalized experiences, connections with other users based on mutual interests with a user's past or current location.

In some embodiments, advertisers may interact directly within the radio app to request the insertion of a target advertisement based on a recognized population of user preferences, demographics, or location. For example, an advertiser outside the immediate geolocation can sign up to serve an advertisement in the radio app by signing up through the radio app, with advertising content and payment supported directly through the radio app. With limited sales resources, such direct interaction with the radio app by advertisers may increase the advertiser market and thus advertising revenue beyond the radio station's traditional market.

Additional user profile information may be used by the radio app or external ad server to filter advertisements according to the user profile obtained from the social media sign in. For example, “Allowed” or “Disallowed” usage of the radio app or programming content presented therein may be indicated by an age of the user for programming content or advertising content that is legally required to be age-gated. Programming content including advertising content may be allowed or disallowed for gambling, gaming, or alcohol related content, or for content that is not suitable for a general user, such as dating, mature, graphic, or violent content. Allowed content may be content that is directed at kids or teens. Gender, age, and other user profile information may additionally provide for providing age-related content based on birthday or by age-range.

Radio station programming content may be provided for maximum listener engagement throughout the day thus increasing the efficacy for the advertisers' air time using demographics, age, and gender to targeted ad content. For example, advertising for a retirement home targeted at age 75 and above listeners will not be provided to users under the age of 75. Similarly, as above, any wine or gambling ads will not be shown to users under the age of 21. Ad content related to health products and services may be shown to men and women only within a selected demographic segment and age group.

In a second portion of the radio app user interface display, there is a Traffic control, a Weather control, and a News control. Each of the controls may open an associated electronic user device app or an associated webpage. For example, the user selection, by clicking or touching on Traffic may open traffic application Google Maps at the user's current location based on the user's travel mode. Traffic information may be provided based on the user's travel mode based on whether the user is driving (or the user's travel mode is unspecified), when the driving mode is associated with a valid departure time at the current time or a time in the future, and/or when the driving mode does not include stopovers or waypoints. Alternatively, the Traffic link may launch a mapping application with the location parameters provided by the electronic user device. Similarly, clicking or touching Weather may open information or link to weather information provided by radio station website based on the user location. Touching or clicking News may open or link to the radio station website. The examples of the links above are not however intended to be limiting to the links to information and information sources that may be provided by the radio app. One of ordinary skill in the art would understand that a variety of sources, content, and methods of access may be presented by the radio app without loss of generality.

In a center portion of the radio app user interface display shown in FIG. 6A, there is a media playback portion having media player controls and a link to Recent Tracks. Media player controls may include Play/Stop buttons for playing, stopping, pausing, and continuing to play programming content from the over-the-air radio station broadcast. Clicking on Recent Tracks may open up the Playlist tab with programming content details feed. The Playlist tab is further described below in relation to menu items at a bottom portion of the radio app user interface.

In some embodiments, below the media playback portion of the radio app user interface, there is a menu bar containing one or more rating buttons and one or more share buttons for sharing programming content or a link thereto by social media. For example, Thumbs Up & Down share buttons may feedback from the user engagement in response to the programming content played for collection and aggregation by an external app server. For example, Twitter and Facebook buttons may send sharing of default or customizable comments in addition to sharing the radio station programming content link. Sharing may include sharing via a messaging application such as text messaging or email or other sharing communications method known in the art.

As shown in FIG. 6B, there is a home screen as shown and described above for FIG. 6A, and additionally showing an ad banner. In one embodiment, the ad banner displayed in the home screen may be from a general ad feed unassociated with the radio station, a radio station advertiser, the user or user profile information. In a preferred embodiment, the ad banner and the selection of the ad displayed to the user may be customized to the particular over-the-air radio broadcast listener associated with the electronic user device, and particularly customized to user information, user profile, user device and mode of travel, present and past user behavior, user location and telemetry data, and user engagement with current and past radio station programming content, including advertising programming content.

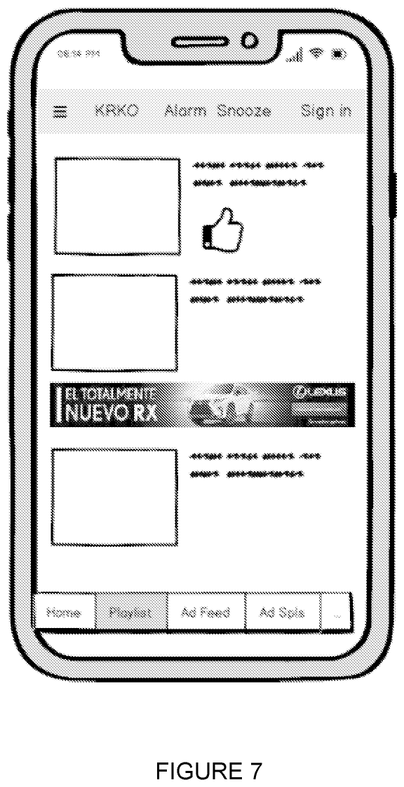

In a bottom portion of the radio app user interface display shown in FIGS. 6A and 7B, there is a menu bar providing control buttons for accessing radio app functions: Home, Playlist, Ad Feed, Ad Specials, and Settings controls. The radio app functions associated with the controls shown at the bottom portion of the radio app, according to this embodiment, are described as follows with reference to FIGS. 7-10.

In a center portion of the radio app user interface, there is a Playlist tab display as shown in FIG. 7. Playlist tab display shoes previously played programs and songs received by the electronic user device and presented to the over-the-air radio broadcast listener. Playlist tab display may include a list in text or graphical depiction, which may include a depiction of an album cover image and title associated with the previously played programs and songs. As described above for the media player portion of the Home display, the Playlist tab display may provide a Thumbs Up button, which may render or update any previous indication and update it accordingly based on a user action such as clicking or touching the button. In some embodiments, if the user clicks Thumbs Up having already indicated a “like” of the associated program or song, an update may increment the count of “likes” previously indicator by the user. One skilled in the art would understand that other arrangements of previously played programs and songs, including other methods of ordering or filtering the display of previously played may be used, and that other methods of indicating, recording, storing, and sharing user indications may be employed without loss of generality.

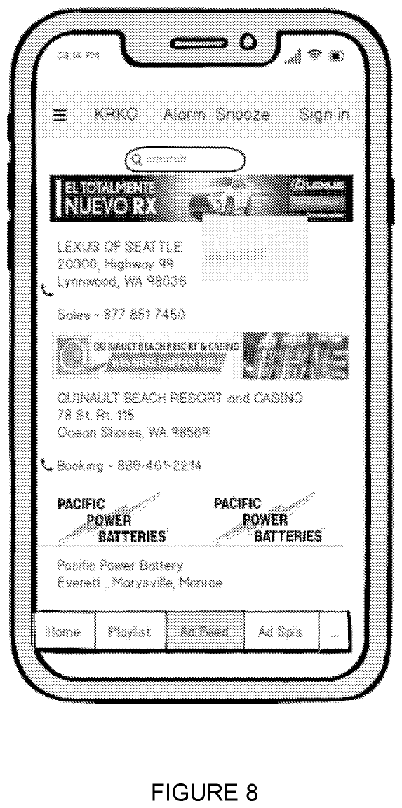

As shown in FIG. 8, there is an Ad Feed tab screen displayed on the electronic user device, according to one embodiment. Ad Feed tab display shows ad banners and associated information. In some embodiments, the Ad Feed tab display may show the ad banner and information matching a current time and may rotate, in a circular fashion, through a list of ad banners until or when a last ad is displayed, or the ad list is exhausted. Ad Feed tab ad banners provide for the user to click or touch the ad banner or ad banner information. User engagement may result in the transmitting of telemetry data regarding the user actions. User engagement with the ad banner or ad banner information may include opening an advertiser website or an ad engagement lead form for capturing the user engagement with the advertisement. In some embodiments, an ad engagement lead form may include, but is not limited to fields: First Name, Last Name, Contact Number, Morning 8 am—Noon, Afternoon 12:00-5 pm, Evening 5-8 pm, Email, Zip code, Message, Call/Tel, and Address. In some embodiments, entering Call/Tel information invokes a telephone call action; in other embodiments, entering Address information invokes a standard map application opened at the location of the entered address.

Ad Feed tab display as shown in FIG. 8 may additionally include a Search function. Search function of the Ad Feed tab display may include search advertising banner information based on time, business name, category of product or service, or other search keyword within advertising programming content received by the radio app or on an external ad server. In some embodiments, the Search function may include customization and filtering of the search using based on data including, but not limited to, the user profile, location, past and current user behavior, time of day, user activity and engagement. Search function may be extended and refined by artificial intelligence and machine learning.

Ad Feed tab display may include ad banners and information interspersed with information on popular programs and special ads, such as specials, promotions, “deal of the day”, which may be associated with the specific radio and which may be inserted at configurable intervals, for example, every five ads. User engagement with the Ad Feed tab display special ads may present and capture a promotion code to offer a discount based on user engagement and activity, e.g. a user of the radio app who drives to a particular coffee shop during morning hours and displays the code gets a free coffee.

In some embodiments, the Ad Feed tab display may prompt the user to enter a form for capturing contact information and to generate a dynamic code unique to the user information and a time stamp. For example, a user with a first name “S” and a last name “D” at time 08:15:36 on May 26, 2019 may be presented with a unique code for coffee shop “CS” as follows: “SDCS08153605262019”. Generated codes may be sent with telemetry and user information and promotional code to an external ad server. One skilled in the art would understand that any form of alphanumeric, text, barcode, or QR code, for example, may be used to present and track a promotional ad banner. Promotional codes may be used by businesses to scan and register user engagement, and telemetry data sent with user information and promotional codes may additionally be used capture and assess over-the-air radio broadcast related promotions.

In some embodiments, using similar methods of providing ad banners and add information, Ad Feed tab display may present sweepstakes contests and listener polls and surveys. Sweepstakes contests and listener polls and surveys may be natively integrated into the programming content which increases system efficiency for the radio station and for the listeners, allowing greater agility in survey and contest administration.

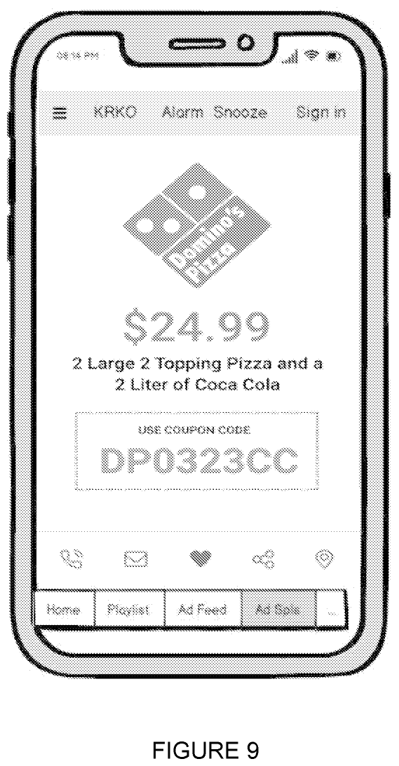

As shown in FIG. 9, there is an Ad Specials (“Ad Spls”) tab screen displayed on the electronic user device, according to one embodiment. As shown, Ad Specials tab display shows an ad banner and ad information. Ad banners and information on the Ad Specials tab display may provide user engagement as with the Ad Feed tab display previously described. Ad Specials tab display may display single instances of promotions, location-based ads, sweepstakes contests, polls and surveys. In some embodiments, the Ad Specials tab display may auto scroll based on a number of identified “special” ads received in the programming content and presented to the over-the-air radio station user on the electronic user device.

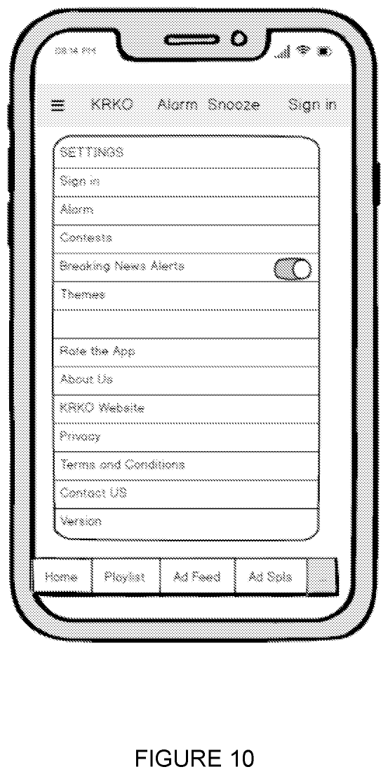

As shown in FIG. 10, there is a Settings tab screen displayed on the electronic user device, according to one embodiment. Settings tab display may include user settings for customization of Sign-in credentials, Alarm settings, Contest selection, Breaking News Alerts feeds, and customizable user interface display Themes. Settings tab display may also include radio app information including Rating, About, radio station Website links, Privacy and legal Terms and Conditions information, and Version and Contact information. One skilled in the art would understand that the Settings tab display may provide for additional configurations and customizations for the radio app not shown without loss of generality.

Further to the detailed description above, now will be described the overall system architecture of the connecting over-the-air radio transmission content to electronic user devices system. In general, the system comprises servers, services, components, modules and other hardware and software structures to consume radio station data and administer configurations; consume radio app and web module telemetry data; consume input data, process it, and send aggregate result to data storage; and services to provide the radio station app and web module data based on radio station time and location data from storage.

Specifically, in some embodiments, the connecting over-the-air radio transmission content to electronic user devices system comprises the following servers, services, components, modules and other hardware and software structures and processes:

Synchronization Server for synchronizing radio ad content aired over the air with the display on the users' electronic user device;

App Server for managing the features of the radio app application like albums and the likes and dislikes of the user-listeners of the radio station listening through the radio app;

Ad Feed Server for displaying the visual ads which are aired over the air;

Ad/AI Processing Server for performing analytics on ad banner engagement by the user, including analyzing the time, location, ad type, voice-to-text of spoken ads to provide further analytics of the user engagement;

Reporting Server for listing the reports regarding telemetry data captured by the app including, but not limited to, for songs liked, ads liked, ad liked by location, ads liked by time of day, and ads interacted by time of day etc.

Campaign Server for providing the advertiser to create specific campaigns by parameters including, but not limited to, demographics, time of day, time in the year (including season), special events, and gender targeting to provide advertisers analytics for targeting potential customers of certain parameters.

The purpose of the synchronization server generally is to provide programming content including advertising content to the radio app at the electronic user device in substantially synchronously with the over-the-air radio broadcast content. These and other purposes of the Synchronization Server will be described more fully below.

In some embodiments, the Synchronization server includes components, modules, and interconnections within and to other system servers, including radio traffic programming servers, and to users' electronic user devices.

In some embodiments, synchronization server synchronizes the over-the-air radio broadcast content to the programming and advertising content sent to the radio app. Data from a radio traffic programming server is sent to the synchronization server which then does a mash up with the over-the-air broadcast stream to display in substantial synchronous real-time ads to the user on the electronic user device of their choice.

The synchronization server receives from the Ad Feed server data including data about the user and electronic user device and preferences and current status. User data may include, but is not limited to, user age, location, and gender, which may be used by the Synchronization server to send one or more appropriate ads to the users via the electronic user device communications as previously described.

In some embodiments, a same ad may have different variations based on user data, for example, a footwear ad may be targeted towards male or female users, with the Synchronization server receiving from the Ad Feed server an appropriate ad based on the above-mentioned facts and also based on a machine learning and prediction model. For example, a generic radio advertisement for shoes may be presented based on user profile data including gender and age. A female user may receive an ad banner for women's shoes, the selection of shoes presented based on whether the female user was over or under 30 years of age. Similarly, a user identified by the user profile data as male may receive an ad for men's shoes based on age. For a male user older than 50, for example, the ad banner presented may include only shoes with arthritic support. The above example is for illustration only and other examples and user data, such as user behavior and telemetry data, including location and geographic location, may be employed to vary ad content without loss of generality.

The synchronization server combines the received data to create combined data to send to the radio app based on the logic mentioned above. Combined data may include, but is not limited to: ad information; advertiser information; spot length; Programming meta data; ad type; air time data is sent; spot creative type; time of day; and date. Based on the program listing and other data received from a radio traffic programming server, the synchronization server may send the combined to the radio app running on one or more users' preferred electronic user device via two-way communications for display substantially synchronously with the programming content received by the radio app via the over the air broadcast. For example, based on the current date and time and based on the over-the-air broadcast content time and date and other data defined above, when the programming or ad content is scheduled for air, the radio app may then synchronize with the programming or ad content in the over-the-air broadcast, for example, the audio stream and meta data and ad data information. The radio app may then detect the time difference between an audio stream on the device from the over-the-air audio stream and adjust the program and ad time on each device based on the lag on each device, thereby dynamically adjusting the ad and the programming to synchronize with the audio stream on the electronic user device.

One challenge of streaming the radio stream on a smart device the time lag introduced by variables such as the device CPU processing speed or memory storage, Wi-Fi speed or cellular signal strength. Such variables may cause a delay in the ads to be displayed if it is not in synchrony with the over-the-air broadcast signal.

In one embodiment, an adaptive mechanism is applied to determine the delay between the programing audio stream and the programming information (e.g. time, title). In this embodiment, the radio app receives the current program title from the streaming server and compares the current time with the programming time provided by the ads and the radio traffic Programing server. By determining the time difference as current time—actual time, as provided in the Programing Listing, the Radio App may synchronize the ad timing with the audio stream or other programming or ad content. Thus, the ad banner is displayed at substantially the same time an audio stream may be playing the over-the-air broadcast ad. Based on current network and phone performance, the determination of time lag provides an adaptive mechanism to synchronize the ads for each user based on the variations of each user's electronic user device and characteristics therefor. While described above is one method of providing and displaying synchronized programming and ad content at the electronic user device, other methods may be used without departing from other inventive aspects of the invention describe herein.

The App Server provides generally for support of the radio app installed on electronic user device(s). App services included configuration and downloading of configurations, customizations, and themes to the radio app. App Server module may further provide settings for the customization of tabs and modules within the Radio App. customized based on the module parameters for a specific over-the-air radio station, including the radio station call letters and other identifiers including, but not limited to slogans, internet address(es), and personal or station identifiers. App Server may duplicate for download configurations and customizations of Radio Apps for multiple Radio Apps customized for a set of affiliated radio stations.

The purposes of the Ad Feed Server generally are to provide ad feeds with themes and embedded telemetry beacons based on the device form factor and capabilities. Ad Feed server may provide banner ad feeds with creatives, for example, images and animations. The Ad Feed banner feed operation may follow the schedule and business rules of the radio stations. The Ad Feed server in communication with the AI-based Ad Processing engine may provide a recommend ad using the AI engine for optimal ad selection and display, including placement timing and slots and providing for data/telemetry information gathering and programming of the ad feed for dynamically mixing the over-the-air radio broadcast audio based on some ad marker. These and other purposes of the Ad Feed Server will be described more fully below.

In some embodiments, the Ad Feed Server is in communication with the AI-based Ad/AI Processing engine which may provide a recommended ad using the Ad/AI Processing engine for optimal ad selection and display, including but not limited to the placement, timing and time slots, and for providing data/telemetry information gathering and programming of ad feed for dynamically mixing the over-the-air radio broadcast audio based on some marker.

The Ad Feed server receives from the radio traffic Programming system data including, but not limited to: music programming data with meta data relating to the over-the-air broadcast programming content; ad information; advertiser information, spot length, programming meta data; ad type (e.g. Commercial, Public Service Announcement, Trade); air time data is sent; spot creative type; time of day; date. Programming meta data received by the Ad Feed server is combined with ad meta data including, but not limited to: banner ad, ad creative, male/female voice talent, variations of banner creative, banner size, banner coupons, if any, and ads optimized for device screen type.

The radio traffic programming system may be a conventional radio station programming scheduler. The radio traffic programming system may contain audio files for songs, talk shows, live audio, and an ad data feed for audio adds to be inserted into the live feed, which combines both the above in a prescheduled pattern to create over the air feed with audio and ads appearing at fixed intervals.

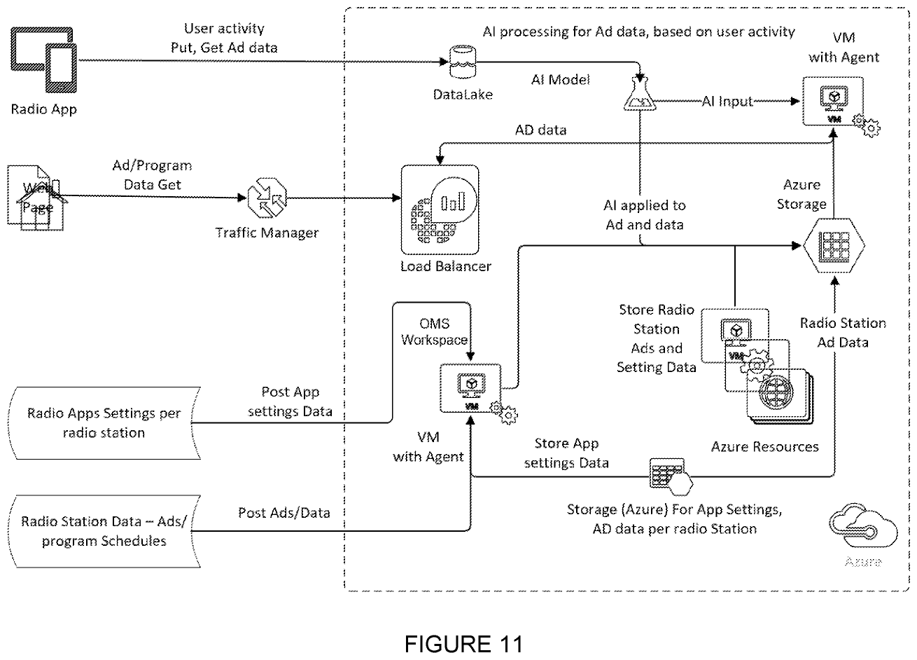

As shown in FIG. 11, there is depicted the components in the operation of the AI processing for ad data based on user activity, according to several aspects of the invention. In one embodiment, user activity data is retrieved from the Radio App and stored for AI processing by an AI Model. Ad Program data is received from a webpage after passing through a Traffic Manager to a Load Balancer. Radio App Settings data for a radio station is received and stored. Radio station Post Ads data including ad data and program scheduling data is received for the radio station. AI Processing using an AI Model is applied to the received user activity, ad program data, app settings data, and post ads data. These and other purposes of the AI Processing Server will be described more fully below.

In some embodiments, the Ad/AI Processing server includes functions of components, modules, and interconnections among components including: Device—sends the telemetry data of each user; Ad Intake feed Server takes the air feed and ad feed; Synchronization Server; and Reporting and AI Server for feeding the reporting and analytical server for the application.

An exemplary process for Ad/AI Processing server includes the functions: 1) Gathering Input Data; 2) Defining Goals and Constraints; 3) Modeling and Training; and 4) Executing and Adjusting Prices. Gathering Input Data includes, but is not limited to, gathering: Transactional data, Product Description data, Past Promotion data, Competition Data, Inventory/Supply data, and Geographic Data. Defining Goals and Constraints includes but is not limited to: Profit maximization; New Segment targeting; Listener Loyalty; and Programming Efficacy. Modeling and Training includes, but is not limited to, training models for: Generalized Linear Models (GLMS), Logistic Regressions, Constraints, and Neural Networks. Factors for Executing and Adjusting Prices for optimal pricing includes, but is not limited to: postal codes, time of day, by season, and advertiser shuffling.

In some embodiments, the features and functions of the AI Processing includes Ad Synchronization, Advertiser Lead Generation, Advertiser Analysis, Programming Analysis, Geo location Analysis, User Poll integration, Advertiser Campaign response forecasting and remediation recommendation, and Machine Learning/AI simulation. Steps of applying the above process, features and functions of the AI Processing, according to some embodiments include: Digital assessment—Radio station GM interview and current digital capability assessment; Technical assessment—Current web architecture and data feed assessment; and Solution deployment—Deploying the application and rolling out the associated business plan.

In some embodiments, the Ad/AI Processing server includes an AI/Machine Learning Analytic Engine for tracking the telemetry data that is sent from each electronic user device. Data received and analyzed by the AI/Machine Learning Analytic Engine may include, but is not limited to: User Device Type (e.g. iPhone model types, Android models); Operating System Type; Session data; User location; User action taken time; and User Actions, including but not limited to: Clicked on phone icon to initiate a call; Clicked on email; icon to send an email; Clicked on location to see driving directions; Clicked on sharing icon; Clicked on favoriting the ad; Clicked on a special ad; Clicked on a contest participation; Clicked on a poll before clicking on the banner; Used the app in foreground or background; Used the app on weekday or weekend; Used the app in the morning, afternoon or evening; Data analyzed by the AI/Machine Learning Analytic engine may be used to predict user behavior and to select for display to the user targeted ads based on: Customer segmentation; Gender; Age; Socio-economic level; Psychographic segmentation; Customer ad targeting; Advertiser churn; Contest fraud detection; Advertiser Ad optimization by time/day/season; Customer Classification; Engaged; Non engaged.

Further to the Ad/AI Processing server there is a Predictive Advertising Module to compare user interactivity and telemetry data behavior when in an anonymous mode (the user is not specifically identified by personally identifying information) and compare it to registered users to predict the unidentified user preferences and demographics. Predictive modeling using the interactivity, participation, location, and the demographics of known, registered user profiles can then be used to target advertising to unknown users, thereby providing that an unidentified user maintains anonymity while still providing for targeting advertisements based on user interactivity, participation, and telemetry data.

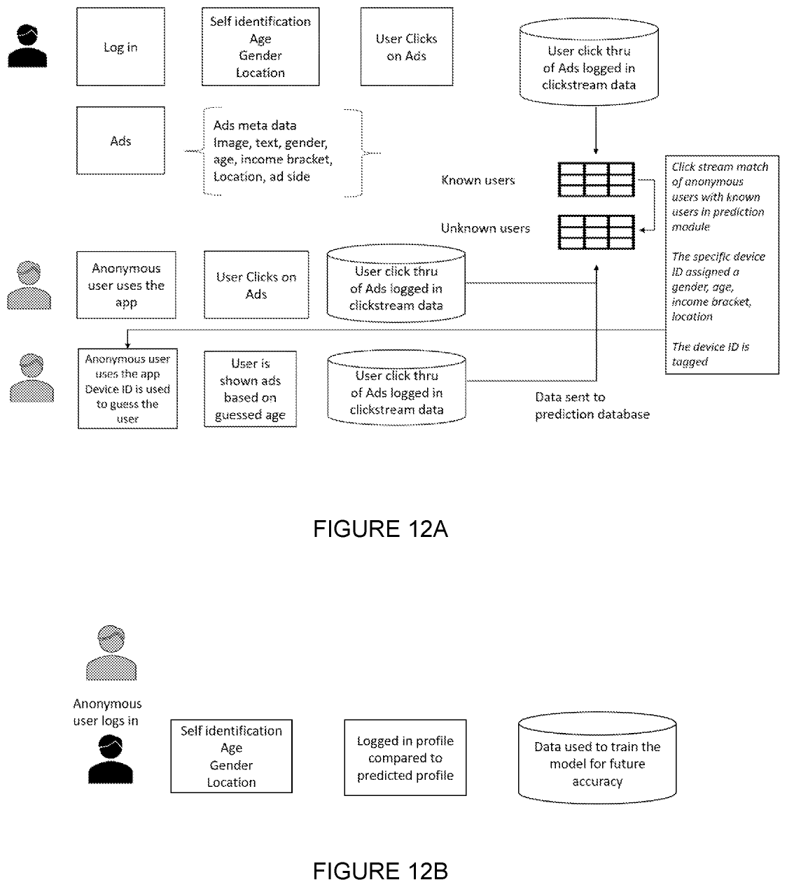

In a preferred embodiment, as depicted in FIG. 12A, when a user launches the radio app for the first time they are given an option to register. At registration, the user may provide gender and location. As users interact with the radio app, registered users' behavior is tracked based on the media content consumed or “liked”, the advertisements the user interacts with. Each ad and its content are tagged with targeting criteria, including but not limited to demographics, age, income, lifestyle (active, family, outdoor etc.), location (if applicable) and a series of other attributes. When an anonymous user clicks on the ad stream or content, the predictive advertising module makes a prediction about the anonymous user. The prediction applies a predicted profile to the anonymous user, predicting the user's age, gender, income, location, lifestyle, and other attributes. Such predictions may used as above for ad targeting, contest profiling, survey profiling, or predicting special promotion outcomes. As further described below, as more users register, their interactivity may be compared to the predictive advertising model for refining the prediction algorithm to the actual user interactivity data.

Specifically, in the Predictive Advertising module, when a listener listens to the radio app there are two modes. In a first mode, the listener is logged in as a registered user. In a second mode the user is listening in anonymous mode. If the listener is logged in, in the first mode, the radio app captures the user's interactivity, telemetry data as above. If the listener is logged in in the second “anonymous” mode, the radio app captures user gender, age, user location, date, time. User interactions are also captured, including but not limited to: song likes, dislikes, ad likes, dislikes and ad interactions. User interactions may include contest participation and poll participation. Each advertisement, song, contest, poll and image associated with the ad, song, or contest includes additional meta data. Each user action is logged and a group affinity to subsegments of users is predicted based on action similarity and classified and given a weightage. For example, ads targeted towards men, e.g. men's beard trimmer, are given a higher weightage as compared to a restaurant, which may be gender non-specific, where higher interactivity by males may skew towards men, but is not a strong predicted or gender. Each data point is given a bias and weight. As further shown in FIG. 12A, the group affinity to subsegments of users data are, in turn, compared with the actions of anonymous users and based on the user clicks and the gender, age or location are predicted.

Prediction of gender, age, or location is performed using techniques such as, in one embodiment, using a deep learning feed forward neural network (DNN) using a three-stage neural network process as follows: First, an Input Layer uses interactivity data along with weightages. Second, a Prediction Layer, comprising a set of nodes in the hidden layer of the DNN represents math functions that modify the input data. Third, an Output Layer outputs the predictions made in the hidden layer which are collected to produce the final output, the Prediction modules prediction that is used to update the anonymous user data.

In the Prediction Layer, each neuron of the DNN takes as input a set of input values wherein each is given a weight, an importance and a bias. Initially, such weights may be assigned manually or in a supervised mode. Once the Predictive Advertising module has accumulated statistically significant user data, clustering algorithms may be used to cluster or group anonymous and known users by the recognition of similarities in the users' interactivity. For example, a statistically significant accumulation of known user and unknown user may be 200,000 user interactions may provide for a high enough confidence to form clusters or groups of anonymous and known users.

As a DNN in particular does not require labels to find similarities, when there are no such labels input manually to learn from, the DNN uses unsupervised learning, thus retaining the potential for producing highly accurate models. Typical advertising meta data may have certain associated labels, e.g. each banner ad may have been tagged as “appliance”, “car”, “hair salon”, “restaurant”. Hence, when a user clicks on the ad, the meta tag or labels help in the classification and matching of records that match similar characteristics, e.g. a known male user clicked on an image that was labeled a “power tool” and the male user's typical age for this label was 25-40. Similarly, when an unknown user clicks similar ads with the labels, the DNN can use it to classify the unknown user using predictive analysis as described herein or similar algorithms to predict the user's gender and age. With the DNN as the predictive model, however, no labels are required, in particular, where there are no labels to learn the user's gender and age from, e.g. ads for home mortgages or new homes which could be generic to genders and age groups. The DNN then uses unsupervised classification, i.e. without human intervention, to correct learning, thus with the potential to return a more accurate model and prediction of the user's demographic.

In a preferred embodiment, as shown in FIG. 12B, when a previously unidentified anonymous user registers and/or logs into the radio app, the self-identification of age, gender and location can be compared to the predicted profile of the user prior to identification. Differences in the prediction compared to the actual demographic and location may then be used to further train the predictive model for greater accuracy. One skilled in the art would understand that other predictive modeling algorithms may be employed to compare known and unknown users to predict the unknown user without departing from the scope of the invention.

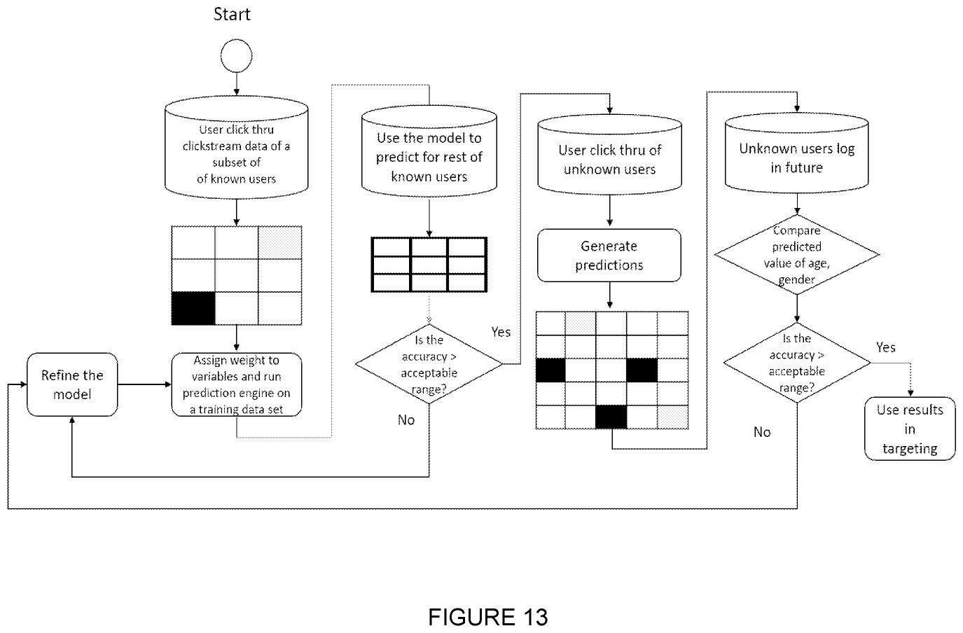

As depicted in FIG. 13, the above data are provided as input to the neural network with a target to build a predictive model for gender, age, segment, social income bracket prediction. The predictive model is evaluated by applying it the unknown data set. If the model's result is not acceptable, then the DNN is retrained by changing its constraints. Once the model results are acceptable, it is evaluated for performance, and finding sufficient performance, the model is ready for the prediction of the anonymous user's demographic. Such prediction may be used to target advertising based on the predicted demographic and all such interactivity and telemetry data as has been previously stored. The known data set of users is split into two sets, including a training set used to predict the variables of other known users. Thus the models accuracy rate can be determined. Once the predictive model is delivering the accuracy within a desired range, the predictive model is then used on anonymous users and values predicted for certain variables. As the anonymous users self-identify on certain triggers, e.g. contest registration or ad personalization offers, the predictive model accuracy is recalibrated. If the predictive model accuracy is within the agreed parameters, the Ad/AI prediction module continues to use the predictive model. If the predictive model accuracy is not within agreed parameters, feedback is sent to the predictive model and the predictive model is further trained and refined until an acceptable level of accuracy is attained.

In an exemplary embodiment, the system may provide an Early Warning System for Radio Stations. The Early Warning System for Radio Stations may include reports on ad responses for each of the advertisers. Such reports may provide the Radio Station and/or Advertiser to change the programming content to elicit more effective responses from user in response to displayed ad content in real-time or substantially real-time thereby providing an intelligent system that dynamically analyzes, alerts, and reports, which may provide guaranteed ad responses to the advertisers in an improved and more timely manner.

The Reporting Server provides aggregated reports of Users, Songs, Views of ads by Advertiser, Metrics on ads, for example, phone calls generated, emails generated, directions looked up, ads shared, or ads favorited by advertiser. In one embodiment, the ability to triangulate the ad responses by zip code both as a user is traveling and when stationary yields insights into when users make a decision on a purchase or the number of actions it takes for a user to commit to a type of purchase.

In some embodiments, the Campaign Server the campaign server allows a radio station advertiser to tailor or customize the ad banner appearing on the electronic user device to the audio or other broadcast message on the radio. For example, if the data for a demographic of a user or users skews toward a particular gender and the advertiser has products that apply to gender, the ad may be adjusted such that the messaging shown to the user reflects the same. Similarly, if the AI Machine Learning Analytical engine identifies to the advertiser the electronic user device type, depending on the product, the Campaign Server may change the banner to the device-specific example. In the above described manner, the campaign server may tailor the ads by the time of day and the type of vehicle or mode of listening to the user.

In some embodiments, there is a Vehicle Mode Determination based on telemetry data received from the radio app on the electronic user device. Vehicle mode determination provides a smart prediction of the type of activity the user of the radio app is presently engaged while listening to the over-the-air radio broadcast. In a preferred embodiment, the vehicle mode determination identifies in what type or activity of transportation the user is engaged, including, but not limited to: bicycling, walking, driving a car, public transit, rail, scooter.

In one embodiment, the vehicle mode may be determined for every over-the-air broadcast listener by periodically receiving accelerometer data on the speed of the electronic user device. If the speed is greater than 25 mph, vehicle mode may presumed be in the mode “Car” or “Public Transit” or “Light Rail”. If speed is 8-20 mph, vehicle mode may be presumed to be in the mode “Bike”. At a slower speed (<8 mph), vehicle mode may be presumed to be in the mode “Pedestrian”. In addition, speed data overlaid with geographic data may be used to filter out slow moving traffic to avoid an erroneously presumption of “Bike” or “Pedestrian”. A Session ID may be tracked to determine if a slow speed was in a same Session ID which was moving faster at an earlier time. Over time the system may refine its vehicle mode determination with intelligent analysis of telemetry and user data to improve predictions of vehicle mode type.

The present disclosure provides, generally, computer systems that are programmed to implement the methods and systems described herein. The computer systems include central processing units (e.g., processors), which can be a single core or multi core processor, or a plurality of processors for parallel processing. The computer systems may include memory (e.g., random-access memory, read-only memory, flash memory), electronic storage units (e.g., hard disk, static RAM, memory stick, SDRAM modules), communication interfaces (e.g., network adapters, wireless adapters) for communicating with one or more other systems, and peripheral devices, such as cache, other memory, data storage and/or electronic display adapters.

The memory, storage units, interfaces, and peripheral devices are known to be communications with the CPU processors through communication buses, which may be a motherboard or a backplane of an electronic user device. Storage memory may be a data storage unit or data repository such as an RDMS database for storing data. Computer systems may be operatively coupled to a computer network (“network”) with the aid of a communication interface.

The networks may be the Internet, an internet and/or extranet, Ethernet, WIFI, WLAN, or an intranet and/or extranet in communication with the Internet. The networks may in some cases be a telecommunication and/or data network. The networks can include one or more computer servers, which can enable distributed computing, such as cloud computing. The networks in some cases with the aid of the computer systems may implement a peer-to-peer network, which may enable devices coupled to the computer system to behave as a client or a server computer. Computer systems may communicate with one or more remote computer systems through the network with a remote computer system of a user, such as a user's electronic user device. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system via networks and other data communications links.

Processors of the computer systems of the present invention may execute a sequence of machine-readable instructions, which can be embodied in a program or software. The instructions may be stored in a memory location. The instructions can be directed to the processor, which can subsequently program or otherwise configure the processor to implement methods of the present disclosure. Processors may be part of a circuit, such as an integrated circuit and one or more other components or modules of the computer systems may be included in a circuit, for example, in some cases, the circuits may be an application specific integrated circuit (ASIC).

Storage units may store files, such as drivers, libraries and saved programs. Storage units may store user data, e.g., user preferences and user programs. Computer systems may in some cases include one or more additional data storage units that are external to the computer systems, such as located on a remote server that is in communication with the computer systems through an intranet or the Internet or other data communications link.

Methods as described herein may be implemented by way of machine (e.g., CPU, processor) executable code stored on an electronic storage location of the computer system, such as, for example, on the memory or other electronic storage unit. Machine executable or machine-readable code may be provided in the form of software. During use, the code may be executed by the processor, retrieved from the storage unit and stored on the memory for ready access by the processor. In some situations, machine-executable instructions may be stored directly to memory. Computer codes may be pre-compiled and configured for use with a machine have a processer adapted to execute the code or can be compiled during runtime. The code can be supplied in a programming language that can be selected to enable the code to execute in a pre-compiled or as compiled fashion.

As described herein, various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software.

As used herein, unless restricted to non-transitory, tangible “storage” media, terms such as computer or machine “readable medium” refer to any medium that participates in providing instructions to a processor for execution. Machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications.

Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system can include or be in communication with an electronic display that comprises a user interface (UI) for providing, for example, user interfaces associated with the connecting over the air radio transmission content to digital devices system. Examples of UI's include, without limitation, a graphical user interface (GUI) and web-based user interface. Methods and systems of the present disclosure can be implemented by way of one or more algorithms. An algorithm can be implemented by way of software upon execution by a CPU/processor.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1. A system for connecting over-the-air radio transmission content to an electronic user device, the system comprising:
a radio station programming source for providing radio station programming content for radio broadcast transmission to one or more over-the-air radio broadcast listeners;
one or more electronic user devices for receiving the radio broadcast transmission and presenting the radio station programming content to the one or more over-the-air radio broadcast listeners,
a radio station synchronization server in communication with the radio station programming source and the one or more electronic user devices;
wherein, the radio station synchronization server is configured to transmit programming content, including advertising content, via two-way communications with the one or more electronic user devices, and
wherein, the programming content including advertising content is transmitted to the one or more electronic user devices for presentation to over-the-air radio broadcast listeners substantially synchronously with the radio station programming content received via the over-the-air radio station broadcast, and
wherein, the radio station synchronization server is configured to receive from the one more electronic user devices, telemetry data including meta data on user behavior, motion, and engagement with the programming content including advertising content received via two-way communications with the radio station synchronization server.

2. A method for connecting over-the-air radio transmission content to electronic user devices, the method comprising:
transmitting, by a radio station programming source, programming content via a radio broadcast transmitter to an over-the-air broadcast listener;
transmitting, by a radio station synchronization server, programming content including advertising content via two-way communications to an electronic user device associated with the over-the-air broadcast listener;
receiving, by the electronic user device of the over-the-air broadcast listener, the radio broadcast programming content and the radio station synchronization server programming content;
presenting, to the over-the-air broadcast listener on the associated electronic user device, the radio station synchronization server programming content substantially synchronously with the radio station programming source content;
capturing, at the electronic user device, meta data of listener engagement with the programming and advertising content;
capturing, at the electronic user device, telemetry data;
transmitting, to the radio station synchronization server via two-way communications, the meta data of listener engagement with the programming and advertising content and the telemetry data; and
receiving, at the radio station synchronization server, the meta data and telemetry data for analysis and reporting.

3. The method of claim 2, wherein the advertising content comprises advertiser contact information including at least one of a telephone number, an email address, website address, or physical address, and wherein the step of capturing meta data of user engagement with the advertising content includes connecting the user to the advertiser by a single-click interaction with the advertiser contact information.

4. The method of claim 2, wherein the advertising content includes special ad content, the special ad content including at least one of an offer, promotion, sweepstakes, or survey identified by a unique code, the method further comprising:
transmitting the special ad content to the electronic user device;
presenting the special ad content on a display of the electronic user device; and
capturing meta data of user engagement with the special ad.

5. The method of claim 2, further comprising:
performing machine learning/AI analytics to the telemetry data, wherein the telemetry data includes location, motion, and speed; and
identifying an over-the-air radio broadcast receiving device as a stationary radio, car radio, mobile radio, mobile phone used by a driver, bicyclist, pedestrian, or other mode of travel of the user based on at least the telemetry data; and
selecting advertising content based on the identified receiving device for improving the relevance of advertising content transmitted to over-the-air radio broadcast listeners.

6. The method of claim 5, further comprising:
receiving telemetry data including accelerometer data on the speed of the electronic user device;
determining whether the speed is greater than a threshold speed, within a range of speeds; or below than a threshold speed; and
comparing the determined speed with geographic data to predict the vehicle mode of the user of the electronic user device; and
selecting advertising content correlated to the predicted vehicle mode of the user for improving the effectiveness of advertising content to over-the-air radio broadcast listeners.

7. The method of claim 2, further comprising:
performing machine learning/AI analytics to the radio station broadcast programming content for categorizing the advertising content;
correlating the advertising content with the meta data of user engagement and user profile data;
identifying the relevant text in the advertising content based on the meta data of user engagement and user profile data; and
selecting advertising content correlated to the relevant text with high rates of user engagement for improving the relevance of advertising content to over-the-air radio broadcast listeners.

8. The method of claim 7, wherein the advertising content is audio content and identifying the relevant text further comprises a step of processing, by natural language processing, to extract key words and phrases for correlating with high rates of user engagement.

9. The method of claim 2, further comprising:
performing machine learning/AI analytics on the meta data of user engagement with the programming and advertising content;
correlating the meta data of user engagement with the programming and advertising content;
selecting advertising content correlated to the meta data of user engagement for improving the relevance of advertising content to over-the-air radio broadcast listeners.

10. The method of claim 9, wherein the correlating the meta data of user engagement with the programming and advertising content further comprises:
performing machine learning/AI analytics on the captured telemetry data;
correlating the captured telemetry data; and
selecting advertising content correlated to the meta data of user engagement and to the telemetry data;
wherein the telemetry data includes geolocation data of the electronic user device, and wherein the selecting of advertising content includes selecting advertising content correlated to the geolocation data for improving the local relevance of advertising content to over-the-air radio broadcast listeners.

11. The method of claim 10, wherein the performing machine learning/AI analytics on the meta data of user engagement with the programming and advertising content further comprises:
capturing the meta data of user engagement and telemetry data in an anonymous mode;
comparing the meta data of user engagement and telemetry data in an anonymous mode to registered listeners to predict the anonymous user preferences and demographics;
predicting anonymous user engagement with advertising content based on the comparing of the meta data of user engagement in an anonymous mode to user engagement with advertising content and telemetry data of other listeners; and
selecting advertising content correlated to the prediction of user engagement with advertising content for improving the relevance of advertising content to over-the-air radio broadcast listeners.

12. The method of claim 11, wherein advertising content further includes meta data associated with a demographic, age, income, lifestyle or location of listeners, the method further comprising:
predicting anonymous listener demographic based on the meta data associated with the advertising content, and wherein selecting advertising content correlated to the prediction of user engagement further includes:
selecting advertising content based on the predicted anonymous user demographics, age, gender, income, lifestyle or location.

13. The method of claim 12, further comprising
associating an anonymous user with a registered user, the registered listener providing a known demographic; and
comparing the received anonymous demographic to the known demographic of the registered listener; and
wherein the predicting anonymous user engagement with advertising content includes refining the prediction of the user engagement with advertising content based on actual user demographic and engagement with advertising content and telemetry data.

14. An electronic user device in communication with a radio station programming content synchronization server, comprising:
a user engagement module for capturing the user interactions via a user interface;
a display module for displaying programming and ad content and other information on the electronic user device;
a media player module for playing media content on the electronic user device;
a configuration module for configuring the radio app to user preferences;
an advertisement module for storing, retrieving, formatting, listing, and presenting advertisements displayed for user interaction;
an authentication module for authenticating the user;
a telemetry module for capturing user engagement data from interactions of the user with the radio station application; and
a communications module for communicating programming and advertising content, telemetry data, and other data capture by the electronic user device; wherein the electronic user device comprises:
a memory, a display, an input, a media player, and a processor and a memory with executable instructions stored thereon configured to:
receive programming content transmitted via a radio broadcast transmitter to an over-the-air broadcast listener;
receive, via two-way communications, programming content including advertising content transmitted from a radio station synchronization server,
present, to the over-the-air broadcast listener on the electronic user device, the radio station synchronization server programming content substantially synchronously with the radio station programming source content;
capture, at the electronic user device, meta data of user engagement with the programming and advertising content;
capture, at the electronic user device, telemetry data; and
transmit, to the radio station synchronization server via two-way communications, the meta data of user engagement with the programming and advertising content and the telemetry data for analysis and reporting.

15. The electronic user device of claim 14, wherein the display of advertising content by the display module includes the display an ad banner, and wherein the ad banner includes a unique embedded telemetry beacon, and further comprising executable instructions configured to:
present the ad banner on a display of the electronic user device;
monitor the position of the embedded telemetry beacon on the display;
capture meta data of user engagement with the ad banner;
capture the position of the embedded telemetry beacon during user engagement with the ad banner; and
based on the embedded telemetry beacon and user engagement meta data, identify the ad banner and ad banner views to obtain counts of viewing the ad banner by the user per unique advertisement.

16. The electronic user device of claim 14, wherein the advertising content includes special ad content, wherein the special ad content includes a coupon or promotion identified by a unique code, and further comprising executable instructions configured to:
present the special ad on a display of the electronic user device;
capture meta data of user engagement with the special ad; and
based on the telemetry data and the meta data of user engagement meta data, provide one or more of an offer, promotion, sweepstakes, survey to the user.

17. The electronic user device of claim 14, further comprising a vehicle mode determination module comprising executable instructions configured to:
receive telemetry data including accelerometer data on the speed of the electronic user device;
determine whether the speed is greater than a threshold speed, within a range of speeds; or below than a threshold speed;
compare the determined speed with geographic data to predict the vehicle mode of the user of the electronic user device.

18. The electronic user device of claim 14, wherein the advertising content comprises advertiser contact information including at least one of a telephone number, an email address, website address, or physical address, and wherein executable instructions stored thereon are further configured to:
capture meta data of user engagement with the advertising content, and
connect the listener via the electronic user device to the advertiser by a single-click interaction with the advertiser contact information.

19. The electronic user device of claim 14, wherein the advertising content includes special ad content, the special ad content including at least one of an offer, promotion, sweepstakes, or survey identified by a unique code, wherein executable instructions stored thereon are further configured to
receive the special ad content radio station programming content synchronization server;
present the special ad content on a display of the electronic user device;
capture meta data of user engagement with the special ad; and
transmit, to the radio station synchronization server via two-way communications, the meta data of user engagement with the special ad content.

20. A radio station programming content synchronization server, in communication with a radio station programming source and a radio station application executing on an electronic user device, comprising:
a processor and memory having instructions stored thereon for execution by the processor configured to:
receive, from a radio station content programming server, programming data on the radio station over-the-air broadcast transmission;
receive, from an app configuration server, configuration and preferences data on radio broadcast listener and profile of the user/listener of the electronic user device;
receive, from an ad feed server, advertising content selected based on the configuration, preferences, and profile of the user; and
transmit the advertising content to the electronic user device for display substantially synchronously with the programming content received by the electronic user device via the over the air broadcast.

21. A radio station programming content synchronization server of claim 20, further in communication with:
an app server for managing the features and preferences of the user of the radio station application;
an Ad/AI processing server for performing analytics on programming content, telemetry data and meta data of user engagement with advertising content;
a reporting server for reporting data regarding telemetry data, meta data on user engagement; and
a campaign server for scheduling, selecting and setting advertising campaign parameters.
